(19) United States
(12) Patent Application Publication
(10) Pub. No.: US 2010/0263420 A1
(43) Pub. Date: Oct. 21, 2010

(54) PROCESS FOR THE CONTINUOUS GRANULATION OF FERTILIZERS

(75) Inventors: Karin Flore, Florsheim-Dalsheim (DE); Holger Barthel, Oftersheim (DE); Reiner Witt, St. Leon-Rot (DE); Bernhard Purucker, Ludwigshafen (DE); Michael Mauss, Neustadt (DE)

Correspondence Address: CONNOLLY BOVE LODGE & HUTZ, LLP, P O BOX 2207, WILMINGTON, DE, 19899, US

(73) Assignee: BASF SE, Ludwigshafen (DE)

(21) Appl. No.: 12/443,243

(22) PCT Filed: Sep. 19, 2007
(86) PCT No.: PCT/EP07/59893

§ 371 Date: Mar. 27, 2009

(30) Foreign Application Priority Data
Sep. 29, 2006 (EP) 06121518.2

(51) Int. Cl. C05C 9/00

(52) U.S. Cl. 71/28

(57) ABSTRACT

The present invention relates to a process for the preparation of fertilizer granules. The process is particularly suitable for the preparation of finely divided fertilizer granules. Furthermore, the invention relates to the granulated fertilizers obtainable by this process, and to their use for fertilizing agricultural and/or horticultural crops.

The present invention relates to a process for the preparation of fertilizer granules. The process is particularly suitable for the preparation of fine particulate fertilizer granules. Furthermore, the invention relates to the granulated fertilizers obtainable by this process, and to their use for fertilizing agricultural and/or horticultural crops.

Fertilizers are nowadays mainly employed in the form of granules. These granules are easy to handle and can, in comparison with powders, be transferred into other containers, and applied, with ease. Moreover, granules are distinguished by good flowability and, in comparison with compacted products, which are distinguished by a comparatively angular and nonspherical particle shape, they show little tendency towards dust formation as the result of abrasion or broken particles.

Fertilizers granules can be prepared by a variety of techniques (cf. Ullmann's Encyclopedia of Industrial Chemistry, 5th Edition 1987, Vol. A 10, pp. 380-386, Wiley-VCH Verlag GmbH, Weinheim). Examples which are employed for the large-scale production of fertilizers are drum granulators, disk granulators, fluidized-bed devices, or mixers. The starting material is employed as either a mash (a paste of salts with a water content of <10% by weight which is pumpable at elevated temperature) or ground and moistened crude salts. Bulk fertilizers usually have granule sizes of from 2.5 to 5 mm.

Devices which can be used for the preparation of special fertilizers in small amounts (approximately 5 to 500 tonnes of product per day) are, for example, mixers with fixed or moving elements built in. Such mixers are charged with finely ground dry raw materials, and the latter are moistened and subsequently granulated. The granulation time in these mixers is usually in the range of from 5 to 10 minutes.

One problem in the granulation of fertilizers is that, as a result of a large-scale production, frequently crude granules with a very broad particle size distribution are produced, so that the yield of granules with the desired size (accepts) is only 25 to 40%. The remainder must be recirculated, which is laborious.

Special fertilizers are frequently employed in the form of fine granules with a particle size of only 0.5 to 3 mm, in some cases only 0.5 to 2.5 mm, in diameter. Lawn fertilizers frequently only consist of granules with a diameter of 0.5 to 2 mm, in order to ensure good penetration of the particles into the turf.

EP-A 479 097 proposes a batchwise operated mixer intended for the granulation of fertilizers, which mixer comprises a stirrer in a rotating, cylindrical container with a base, which stirrer is arranged off-center in the container, i.e. within a certain distance from the center of rotation of the container, and which mixer comprises a stripper which is arranged at the edge of the container in such a way that it does not interfere with the rotation of the scraper. The size of the fertilizer granules obtainable with this device depends, inter alia, on the speed of rotation of the stirrer. Such mixers are commercially available, for example from Maschinenfabrik Gustav Eirich, 74732 Hardheim.

DE-A 100 62 598 proposes to carry out the agglomeration of a fertilizer in powder form to give granules in a batchwise operated mixing device which is equipped with an annular, nonrotating mixing chamber, a centrally arranged mixer which has mixing tools attached to it which extend into most of the mixing chamber, and a rotating stirrer attached to the mixer within the mixing-tool zone. Fertilizer granules with a high yield of the useful particle size fraction can be prepared in this device on an industrial scale. Here, the residence time (granulation time) plays an important role. To start the formation of granules, a granulating liquid is applied to the powdery bulk material. It is fed in over a period of time from 20 seconds to 5 minutes, and the mixing of the moistened material is then continued for a further 2 to 30 minutes. The longer the mixing time, the more the granules are depleted of fines, so that the particle size distribution becomes more narrow. After a granulation time of several minutes, the particle size distribution is shifted towards coarser agglomerates. After granulation times of at least 4 minutes, yields of the useful fraction of from 1.0 mm to 3.5 mm of 65% or above can be obtained with this mixing device.

Although the process described in DE-A 100 62 598 leads to a high yield of the useful fraction for conventional granule sizes of from 1.0 mm to 3.5 mm, it certainly has disadvantages. More finely particulate fertilizer granules, i.e. those with an upper limit of the useful fraction of 2.5 mm or less, can only be prepared by this process in a markedly lower yield. Moreover, the process has the disadvantage that the mixer is operated batchwise, which requires an additional effort in order to integrate the granulation process into those parts of the system which are arranged upstream and downstream and which, as a rule, operate continuously. Moreover, the type of device has a complicated geometry of the mixing tools, and, as the result of the shape of the mixing chamber, a large area which comes into contact with the product, which easily leads to caking and damage to the mixing tools.

It was an object of the present invention to provide a process which permits the preparation of finely particulate fertilizer granules with a high yield of the useful fraction. It was a further object of the present invention to provide a continuous process for the preparation of finely particulate fertilizer granules.

This object is achieved by a process for the continuous granulation of fertilizers using a mixer with a horizontally arranged cylindrical mixing chamber and a rapidly rotating shaft which is centrally arranged in this mixing chamber and equipped with mixing tools.

The invention thus relates to a process for the preparation of fertilizer granules, in which
a fertilizer in powder form is continuously introduced on one side (inlet side), into a mixer with a horizontally arranged cylindrical mixing chamber and a rapidly rotating shaft which is centrally arranged in this mixing chamber and equipped with mixing tools,
the liquid required for the granulation is simultaneously fed into the mixing chamber continuously in the vicinity of the powder inlet, and
the crude granules formed continuously leave the mixer on the side opposite the inlet side (outlet side).

The shaft which is centrally arranged within the cylindrical mixing chamber of the mixer is equipped with mixing tools which may have the form of paddles, pins or pointed beaters. The residence time of the product in the mixer can be influenced by the shape and arrangement of the tools. For example, when using paddle-shaped mixing tools or mixing tools which are flattened on at least one side, a particularly short residence time can be obtained by adjusting the paddle angle in the direction of movement, which brings about the transport of the product towards the outlet side. If, in contrast, some of the mixing tools are adjusted to a paddle angle which brings about a counter transport of the product in the mixer towards the inlet side, the residence time of the product in the mixer can thus be prolonged. In the process according to the invention, the mean residence time of the fertilizer in the mixer is generally less than 2 minutes, preferably between 10 seconds and 1 minute. The mean residence time is thus markedly shorter than in other processes employed for the granulation of fertilizers. A high mass flow rate can therefore be achieved with the process according to the invention while using relatively small equipment which requires little space and comparatively small drive units, which is a great advantage especially for fertilizers which are, as a rule, produced in large amounts.

The rotational speed of the shaft is, as a rule, not more than 4000 rpm, preferably in the range of from 800 to 3000 rpm. It should be selected in such a way that the tip speed at which the mixing tools move in the mixing chamber at their outermost end is between 8 and 50 m/s, preferably between 10 and 40 m/s. As the result of the high tip speed of the mixing tools, the product is distributed, and moved, in the shape of an annular layer on the internal wall of the mixing chamber, with high local energy input being ensured.

As a result, the fertilizer granules obtained by the process according to the invention are distinguished by a high grain hardness, despite the relatively short residence time in the mixer, which is comparable to the grain hardness of granules obtained with other processes with considerably longer residence times in the granulator.

In general, the granulation process is carried out at temperatures of from 10 to 120° C., preferably 20 to 60° C. The mixer to be used in accordance with the invention can be equipped with a heating or cooling jacket in order to adjust the temperature.

Since the mixing tools and the mixing chamber are subject to high wear, the mixing tools can be provided with a coating against wear and tear, and the internal wall of the mixing chamber can be provided with a coating or internal shell, for example a Teflon® coating or a coating with another polymer, to reduce caking, which coating can be replaced and renewed from time to time.

Introducing the fertilizer in powder form into the mixing chamber can be done for example via an inlet port which is arranged in the vicinity of one of the end walls of the cylindrical mixing chamber (inlet side). The liquid required for the granulation can be fed continuously into the mixing chamber or the inlet port, either under atmospheric pressure or else under an absolute pressure of from approximately 1 to 20 bar, for example via flexible tubes or feed pipes which are fitted in the feeder piece or in the wall of the mixing chamber in the vicinity of the powder inlet. As the result of the combination of the shape, arrangement and rotational speed of the mixing tools, the liquid supplied is distributed rapidly and uniformly in the annular layer.

In the process according to the invention, the fluid required for the granulation (granulation fluid) is fed continuously into the mixing chamber. Fluids which can be used as granulation liquids are water, aqueous solutions of fertilizer salts or their mixtures in various concentrations, organic substances such as, for example, molasses, bagasse, lignosulfonates or aqueous solutions of one or more of these substances and/or meltable organic substances such as, for example, fatty alcohols, waxes or polyethylene glycols. Water or an aqueous fertilizer salt solution is preferably employed as the granulation fluid. As a rule, the granulation fluid is used in an amount of from 0.5 to 40% by weight, preferably from 5 to 30% by weight, in each case based on the total weight of fertilizer and granulation fluid. When using an aqueous granulation fluid, the water content of the resulting mixture is generally between 1 and 30% by weight, preferably between 1 and 20% by weight and especially preferably between 3 and 15% by weight.

The crude granules leave the mixer continuously on the side of the mixing chamber opposite the inlet side (outlet side). To this end, it is possible to fit the bottom half of the mixing chamber for example with a discharge port with a pipe. An outflow flap which can either be adjusted mechanically or else controlled pneumatically and which is fitted within the discharge port permits the degree of filling in the mixer to be regulated.

The crude granules obtained can subsequently be processed further, such as by processing steps conventionally used in the production of fertilizers, such as drying, cooling, screening, conditioning or aftertreatment, for example with anticaking agents, anti-dust agents, colorants, active, substances or similar agents.

It has been found that, despite the short residence time in the mixer, surprisingly finely particulate fertilizer granules with a high accepts yield can be prepared with the process according to the invention. The particle size distribution of the crude granules obtained shows a high percentages in the range of from 0.1 to 3 mm, especially from 0.3 to 2.5 mm and very especially from 0.5 to 1.6 mm, which percentage is desired for finely particulate fertilizers. The particle size distribution of the granules depends on the composition of the fertilizer and can be adjusted via the temperature, the ratio between granulation fluid and fertilizer, the rotational speed of the granulator shaft and the residence time in the mixer.

The mixer to be used in accordance with the invention is a type of mixer which is known per se. Mixers of this type are manufactured and sold for example by Gebr. Lodge, 68219 Mannheim, (type K-TT bzw. CB) and Ruberg-Mischtechnik KG, 33106 Paderborn, (Typ RMG).

EP-A 0 264 049 describes the preparation of granules made of organic substances, where, inter alia, granulators with a rapidly rotating shaft are used. In the process according to the invention, in contrast, fertilizers made of mainly inorganic components are produced, with especially finely particulate granules being obtained in surprisingly high yields, which are markedly higher than the yields obtained with other processes. At the same time, the residence time of the material in a mixing chamber is substantially shorter than in other known fertilizer granulation processes, whereby large mass throughputs can be obtained with relatively small devices.

The fertilizers employed are present in powder form, as a rule with a particle size distribution with a mass fraction of at least 50% below 500 μm and at least 95% below 1000 μm, preferably at least 50% below 300 μm and at least 95% below 500 μm. The mean particle size x₅₀ of the fertilizers employed is generally in the range of from approximately 10 to approximately 400 μm, preferably in the range of from approximately 15 to approximately 300 μm. The raw materials can consist of pure fresh material or of a mixture of fresh material and moist or dry recycle material, which may be the product of an earlier agglomeration process.

The fertilizers employed in the process according to the invention may take the form of straights or of compound fertilizers. Constituents of these fertilizers which are feasible are all customary fertilizer components, nitrogen sources which may be used being, for example, ammonium sulfate, ammonium nitrate, ammonium chloride, ammonia sulfa-nitrate, urea, cyanamide, dicyanodiamide, sodium nitrate, Chile saltpeter or calcium nitrate, and also slow-release fertilizers such as oxamide, urea/formaldehyde condensates, urea/acetaldehyde condensates or urea/glyoxal condensates, for example ureaform, acetylenediurea, isobutylidenediurea or crotonylidenediurea. It is also possible for compounds to be present which comprise one or more of the following plant nutrients: phosphorus, potassium, magnesium, calcium or sulfur, and compounds which comprise the trace elements boron, iron, copper, zinc, manganese or molybdenum. Examples of such compounds are monoammonium phosphate, diammonium phosphate, superphosphate, Thomas phosphate, triple superphosphate, dicalcium phosphate, potassium phosphate, partially or fully digested crude phosphates, potassium nitrate, potassium chloride, potassium sulfate, dipotassium phosphate, magnesium sulfate, magnesium chloride, kieserite, dolomite, lime, colemanite, boric acid, borax, iron sulfate, copper sulfate, zinc sulfate, manganese sulfate, ammonium molybdate or similar substances. Moreover, the fertilizers may comprise one or more active substances such as, for example, nitrification inhibitors, urease inhibitors, herbicides, fungicides, insecticides, growth regulators, hormones, pheromones or other plant protection agents or soil adjuvants in amounts of from 0.01 to 20% by weight, based on the finished fertilizer. Complexing agents such as EDTA or EDDHA may also be present. It is preferred to use nitrogen fertilizers, in particular slow-release nitrogen fertilizers, such as ureaform, acetylenediurea, isobutylidenediurea or crotonylidenediurea.

The present invention furthermore relates to granulated fertilizers which are obtainable by the process described at the outset.

In accordance with a preferred embodiment of the invention, the crude granules of the granulated fertilizers have a particle size distribution with a mass fraction of at least 50% in the range of from 0.5 to 1.6 mm.

The granulated fertilizers which can be obtained by the process according to the invention are suitable for use in the fertilization of agricultural and/or horticultural crops. They are especially suitable in the field of landscaping and for fertilizing lawns and plants in pots. The invention therefore furthermore relates to the use of granulated fertilizers for fertilizing agricultural and/or horticultural crops.

The examples which follow are intended to illustrate the invention in greater detail.

### EXAMPLES

### Materials Used

### Solid 1:

Solids mixture consisting of:

| | |
|---|---|
| isobutylidenediurea (technical grade) | 47% by weight |
| ammonia sulfa-nitrate | 8% by weight |
| diammonium phosphate | 12% by weight |
| potassium sulfate | 23% by weight |
| dolomite | 7% by weight |
| kieserite | 3% by weight |

### Solid 2:

Solids mixture consisting of:

| | |
|---|---|
| isobutylidenediurea (technical grade) | 28% by weight |
| diammonium phosphate | 61% by weight |
| potassium sulfate | 11% by weight |

### Solid 3:

| | |
|---|---|
| isobutylidenediurea (technical grade) | 100% by weight |

### Solid 4:

Solids mixture consisting of:

| | |
|---|---|
| isobutylidenediuree (technical grade) | 22% by weight |
| ammonia sulfa-nitrate | 21% by weight |
| diammonium phosphate | 16% by weight |
| potassium sulfate | 32% by weight |
| dolomite | 5% by weight |
| kieserite | 4% by weight |

### Solid 5:

Solids mixture consisting of:

| | |
|---|---|
| isobutylidenediurea (technical grade) | 20% by weight |
| ammonia sulfa-nitrate | 41% by weight |
| diammonium phosphate | 12% by weight |
| potassium sulfate | 18% by weight |
| dolomite | 5% by weight |
| kieserite | 4% by weight |

### Granulation Fluid:

Aqueous solution of potassium sulfate and ammonium sulfate, with a solids component of 60% by weight, or water (in the case of example 7)

### Examples 1 to 7

### Mixer

Annular-layer mixer type K-TT 20 from Gebr. Lödige, Division Drais, D-68219 Mannheim, length of the mixing chamber: 1200 mm, diameter of the mixing chamber: 200 mm

The mean residence time in this mixer is approximately 10 to 35 seconds.

The granulations were performed at room temperature without additional heating. As a result of the high input of mechanical energy, however, the temperature of the fertilizer during the granulation process may rise to up to 60° C.

The test products were dried in the drying oven at 80° C.

TABLE 1
Exemplary experiments 1 to 7 at room temperature in the annular-layer mixer type K-TT 20

| | Example 1 | Example 2 | Example 3 | Example 4 | Example 5 | Example 6 | Example 7 |
|---|---|---|---|---|---|---|---|
| Solid employed | Solid 1, | Solid 1, | Solid 1, | Solid 2, | Solid 2, | Solid 2, | Solid 3 |
| | particle | particle | particle | particle | particle | particle | particle |
| | diameter | diameter | diameter | diameter | diameter | diameter | diameter |
| | x₅₀ = 150 μm | x₅₀ = 39 μm | x₅₀ = 39 μm | x₅₀ = 300 μm | x₅₀ = 77 μm | x₅₀ = 77 μm | x₅₀ = 15 μm |
| Throughput of | 150 kg/h | 150 kg/h | 150 kg/h | 150 kg/h | 150 kg/h | 150 kg/h | 50 kg/h |
| solids | | | | | | | |
| Throughput of | 23 kg/h | 25 kg/h | 25 kg/h | 20 kg/h | 25 kg/h | 25 kg/h | 12.7 kg/h |
| granulation | | | | | | | (water) |
| fluid | | | | | | | |
| Moisture | 5.9% | 6.6% | 6.6% | 6.4% | 6.6% | 6.1% | 25.4% |
| Tip speed | 16 m/s | 16 m/s | 26 m/s | 16 m/s | 26 m/s | 37 m/s | 16 m/s |
| Yield of useful | 57% | 74% | 64% | 66% | 59% | 70% | 75% |
| fraction | | | | | | | |
| (0.5-1.6 mm) | | | | | | | |

### Results

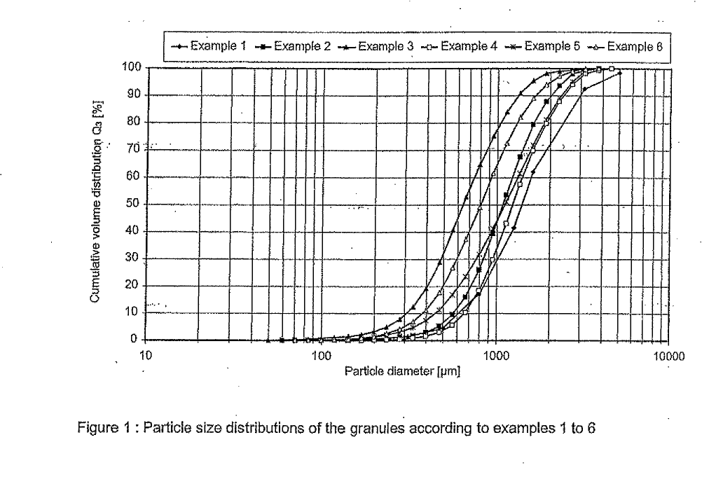

The experiments described in examples 1 to 7 gave finely-particulate fertilizer granules. The particle size distribution of the test products of examples 1 to 6 are shown in FIG. 1. The yields of the useful fraction in the range between 0.5 mm and 1.6 mm are mentioned in table 1.

### Example 8 to 15

### Comparative Examples

By way of comparison, various batchwise experiments were carried out with other mixers. The following devices were used:

Mixer type R02 from Maschinenfabrik Gustav Eirich GmbH & Co. KG, D-74732 Hardheim, mixing tool arranged off-center, rotating product container, fill level 5 l.

Mixer type R23 from Maschinenfabrik Gustav Eirich GmbH & Co. KG, D-74732 Hardheim, mixing tool arranged off-center, rotating product container, fill level 1200 l.

Turbine mixer THZ 500 from TEKA Maschinenbau GmbH, 0-67480 Edenkoben, fill level 500 l.

TABLE 2
Comparative experiments 8 to 15 at room temperature with different mixers

| | | | Example | Example | Example | Example | Example | Example |
|---|---|---|---|---|---|---|---|---|
| | Example 8 | Example 9 | 10 | 11 | 12 | 13 | 14 | 15 |
| Solid | 2 | 2 | 2 | 4 | 5 | 5 | 5 | 5 |
| employed | | | | | | | | |
| Mixer | R02 | R02 | R02 | R23 | THZ 500 | THZ 500 | THZ 500 | THZ 500 |
| Tip speed | 16.4 m/s | 16.4 m/s | 16.4 m/s | 19.2 m/s | 11 m/s | 11 m/s | 11 m/s | 11 m/s |
| Moisture | 6.3% | 6.3% | 6.3% | 7% | 7.5% | 7.5% | 7.5% | 7.5% |
| Residence | 30 s | 60 s | 120 s | 4~6 min | 3 min | 5 min | 7 min | 9 min |
| time | | | | | | | | |
| Yield of | 17% | 25% | 34% | ~31% | 46% | 49% | 43% | 25% |
| useful | | | | | | | | |
| fraction | | | | | | | | |
| (0.5-1.6 mm) | | | | | | | | |

The yields of the useful fraction in the range of between 0.5 mm and 1.6 mm in the comparative experiments are all lower than in the case of the experiments according to the invention.

1-7. (canceled)

8. A process for preparing finely particulate fertilizer granules, wherein the crude granules have a particle size distribution with a mass fraction of at least 50% in the range of from 0.5 to 1.6 mm, comprising
continuously introducing a pulverulent fertilizer into a mixer via an inlet on one said of said mixer (inlet side), wherein said mixer comprises a horizontally arranged cylindrical mixing space and a rapidly rotating shaft which is centrally arranged in this mixing space and equipped with mixing tools on one side; and
continuously and simultaneously metering liquid required for granulation of said fertilizer into said mixing space at location in the vicinity of said inlet;
wherein crude granules formed as a result continuously leave the mixer from the side opposite the inlet side (outlet side).

9. The process of claim 8, wherein the circumferential speed at which said mixing tools fitted to said shaft move in the mixing space at their outermost end is in the range of from 8 and 50 m/s.

10. The process of claim 8, wherein the mean residence time of the fertilizer in the mixer is less than 2 minutes.

11. The process of claim 8, wherein the pulverulent fertilizer employed has a particle size distribution with a mass fraction of at least 50% below 500 μm and at least 95% below 1000 μm.

12. The process of claim 8, wherein the pulverulent fertilizer employed consists either of pure fresh material or of a mixture of fresh material and moist or dry returns.

13. The process of claim 8, wherein the fertilizer comprises at least one slow-release urea component selected from the group consisting of ureaform, acetylenediurea, isobutylidenediurea, and crotonylidenediurea.

14. The process of claim 8, wherein the amount of said liquid used is in the range of from 0.5 and 40% by weight based on the total of fertilizer and granulation fluid.
